(19) United States
(12) Patent Application Publication
(10) Pub. No.: US 2024/0103470 A1
(43) Pub. Date: Mar. 28, 2024

(54) INFORMATION PROCESSING APPARATUS AND INFORMATION PROCESSING METHOD

(71) Applicant: Kioxia Corporation, Tokyo (JP)

(72) Inventors: Yuma YOSHINAGA, Kawasaki Kanagawa (JP); Atsushi MAESONO, Yokkaichi Mie (JP); Osamu TORII, Minato Tokyo (JP); Shinichiro TOMIOKA, Yokkaichi Mie (JP); Shinichiro MANABE, Yokohama Kanagawa (JP)

(73) Assignee: Kioxia Corporation, Tokyo (JP)

(21) Appl. No.: 18/456,209

(22) Filed: Aug. 25, 2023

(30) Foreign Application Priority Data
Sep. 16, 2022 (JP) 2022-147949

(51) Int. Cl. G05B 19/042

(52) U.S. Cl. CPC G05B 19/042

(57) ABSTRACT

An information processing apparatus that updates a regression coefficient parameter based on a predetermined objective function including a regularization term for each of a plurality of elements characterized by a task and a feature value, the information processing apparatus comprising processing circuitry. The processing circuitry selects an element which is an update target of the regression coefficient parameter from the plurality of elements, fixes a value of the regularization term of an unselected element, selects a calculation expression for updating a regression coefficient parameter of the selected element based on a regression coefficient parameter of the unselected element, and updates the regression coefficient parameter of the selected element based on the selected calculation expression.

### CROSS REFERENCE TO RELATED APPLICATIONS

This application is based upon and claims the benefit of priority from the prior Japanese Patent Application No. 2022-147949, filed on Sep. 16, 2022, the entire contents of which are incorporated herein by reference.

### FIELD

Embodiments described herein relate generally to an information processing apparatus and an information processing method.

### BACKGROUND

Since it is not easy to manually analyze a huge amount of data, a technique of analyzing data by a computer by using a regression model has been proposed. More specifically, a method for updating a regression coefficient parameter in units of vectors in which all tasks are grouped for a feature value set for each task has been proposed. In this method, the regression coefficient parameter is repeatedly updated until a convergence condition is satisfied.

Although the regression coefficient parameter is provided for each task, in a method of the related art, a regression coefficient parameter in an n-th number of times is updated by using a regression coefficient parameter in an (n−1)-th number of times. Thus, unless the regression coefficient parameters of all the tasks of each number of times are obtained, a regression coefficient parameter in a next number of times cannot be obtained, and there is a problem that it takes time to update the regression coefficient parameter provided for each task.

### BRIEF DESCRIPTION OF THE DRAWINGS

FIG. 1 is a block diagram illustrating a schematic configuration of an information processing apparatus according to a first embodiment.

FIG. 2 is a diagram schematically illustrating a procedure for updating a regression coefficient parameter for each element.

FIG. 3 is a diagram illustrating a procedure for updating a regression coefficient parameter according to a comparative example.

FIG. 4 is a diagram illustrating a procedure for updating a regression coefficient parameter according to a comparative example.

FIG. 5 is a diagram illustrating a position of an element of an update target.

FIG. 6 is a diagram illustrating an update result of a regression coefficient parameter in a case where initialization is performed in Equation (15) and in a case where an initial value is set to zero.

FIG. 7 is a flowchart illustrating a processing operation of the information processing apparatus according to the first embodiment.

FIG. 8 is a flowchart according to an example in which FIG. 7 is further embodied.

FIG. 9 is a diagram for describing a task and an objective variable Y when defect analysis of a semiconductor wafer is performed.

FIG. 10A is a diagram illustrating a method for selecting each element in an arrangement order of elements.

FIG. 10B is a diagram illustrating a method for selecting each element in descending order of an absolute value of a regression coefficient parameter.

FIG. 10C is a diagram illustrating a method for selecting each element in descending order of an absolute value of a difference before and after the update of the regression coefficient parameter.

FIG. 11A is a flowchart for describing a first selection method performed by a calculation expression selection unit.

FIG. 11B is a flowchart for describing a second selection method performed by the calculation expression selection unit.

FIG. 12 is a diagram for describing an element selected by an update target selection unit.

FIG. 13 is a diagram illustrating an example in which an update target selection unit schedules in advance an element to be selected for each time.

### DETAILED DESCRIPTION

In general, according to the embodiment, an information processing apparatus that updates a regression coefficient parameter based on a predetermined objective function including a regularization term for each of a plurality of elements characterized by a task and a feature value, the information processing apparatus comprising processing circuitry. The processing circuitry configured to select an element which is an update target of the regression coefficient parameter from the plurality of elements, fix a value of the regularization term of an unselected element, select a calculation expression for updating a regression coefficient parameter of the selected element based on a regression coefficient parameter of the unselected element, and update the regression coefficient parameter of the selected element based on the selected calculation expression. Hereinafter, information processing apparatuses of the present disclosure will be described with reference to the drawings.

### First Embodiment

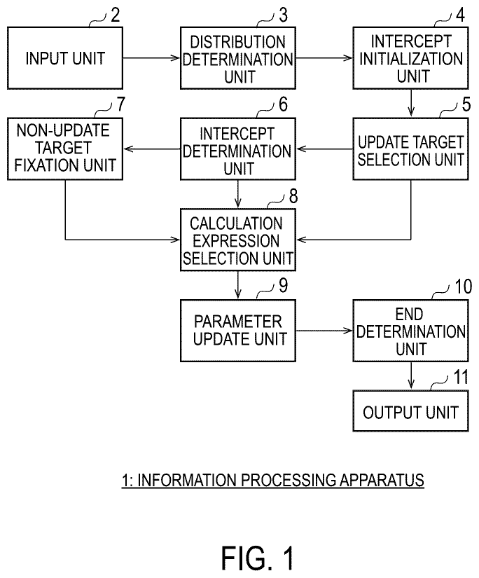

FIG. 1 is a block diagram illustrating a schematic configuration of an information processing apparatus 1 according to a first embodiment. The information processing apparatus 1 of FIG. 1 updates a regression coefficient parameter based on a predetermined objective function including a regularization term for each of a plurality of elements characterized by a task and a feature value. The regression coefficient parameter is repeatedly updated, and thus, the objective variable can be accurately predicted by using an explanatory variable including the feature value and the regression coefficient parameter.

The information processing apparatus 1 of FIG. 1 includes an input unit 2, a distribution determination unit 3, an intercept initialization unit 4, an update target selection unit 5, an intercept determination unit 6, a non-update target fixation unit 7, a calculation expression selection unit 8, a parameter update unit 9, an end determination unit 10, and an output unit 11. In FIG. 1, the update target selection unit 5, the non-update target fixation unit 7, the calculation expression selection unit 8, and the parameter update unit 9 are essential components, and other components are arbitrary components. The information processing apparatus 1 according to the present embodiment may include, for example, processing circuitry. For example, the processing circuitry executes at least one processing operation of the input unit 2, the distribution determination unit 3, the intercept initialization unit 4, the update target selection unit 5, the intercept determination unit 6, the non-update target fixation unit 7, the calculation expression selection unit 8, the parameter update unit 9, the end determination unit 10, or the output unit 11 of FIG. 1.

The input unit 2 inputs objective variables and explanatory variables. The input unit 2 may acquire the objective variable and the explanatory variable from a database (not illustrated) or the like. The objective variable is, for example, a defect rate. The explanatory variables are various elements that influence the defect rate, and are, for example, a manufacturing process, a manufacturing device, a manufacturing date, and the like. In addition, the input unit 2 inputs an initial value of the regression coefficient parameter.

The distribution determination unit 3 determines a form of a probability distribution of the objective variable calculated by inputting the explanatory variable and the regression coefficient parameter to a regression equation. The form of the probability distribution includes, for example, a Gaussian distribution and a Poisson distribution. In the present specification, a procedure for updating the regression coefficient parameter for the Poisson distribution will be mainly described.

The intercept initialization unit 4 initializes an intercept of the regression coefficient parameter when the objective variable is a specific probability distribution. The intercept of the regression coefficient parameter may be referred to as an offset value of the regression coefficient parameter. Initializing the intercept (offset value) refers to setting a part of terms (a second term and subsequent terms on a right side) of Equation (10) to be described later representing the intercept to zero.

The update target selection unit 5 selects an element which is an update target of the regression coefficient parameter from a plurality of elements. In the first embodiment, since the regression coefficient parameter is updated for each task, the update target selection unit 5 selects one element in principle. However, as will be described later, in a case where kinds of processing of updating regression coefficient parameters of a plurality of tasks are performed in parallel, the update target selection unit 5 selects a plurality of elements.

The intercept determination unit 6 determines whether or not the regression coefficient parameter of the element selected by the update target selection unit 5 corresponds to the intercept of the regression coefficient parameter.

The non-update target fixation unit 7 fixes a value of a regularization term of an element not selected by the update target selection unit 5 (non-update target element). The value of the regularization term of the element of the non-update target is fixed, and thus, the processing of updating the regression coefficient parameter can be simplified.

The calculation expression selection unit 8 selects a calculation expression for updating the regression coefficient parameter of the element selected by the update target selection unit 5 (update target element) based on the regression coefficient parameter of the element not selected by the update target selection unit 5 (non-update target). The calculation expression selection unit 8 switches the calculation expression of the element selected by the update target selection unit 5 depending on whether or not the intercept determination unit 6 determines that the element corresponds to the intercept. More specifically, in a case where the intercept determination unit 6 determines that the element corresponds to the intercept, the calculation expression selection unit 8 selects a calculation expression for calculating the regression coefficient parameter corresponding to the intercept. In a case where the intercept determination unit 6 determines that the element corresponds to the intercept, the calculation expression selection unit 8 may select calculation expressions different from each other depending on whether or not to initialize the intercept.

The parameter update unit 9 updates the regression coefficient parameter of the element selected by the update target selection unit 5 based on the calculation expression selected by the calculation expression selection unit 8.

The end determination unit 10 determines whether or not the regression coefficient parameter satisfies a convergence condition as a result of repeating the update of the regression coefficient parameter multiple number of times. When the convergence condition is not satisfied, the regression coefficient parameter is updated again, and when the convergence condition is satisfied, the last updated regression coefficient parameter is sent to the output unit 11. The output unit 11 outputs the last updated regression coefficient parameter.

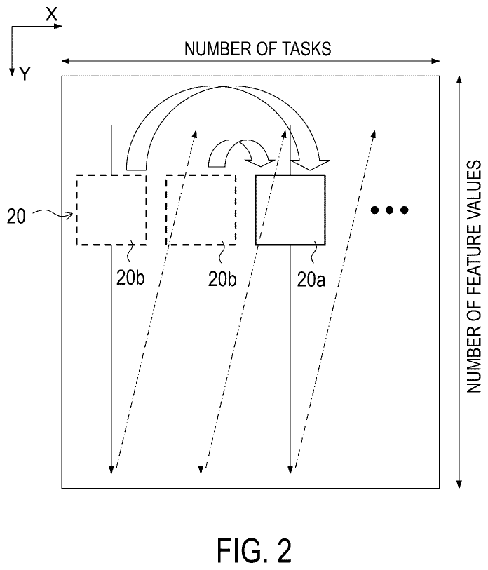

FIG. 2 is a diagram schematically illustrating a procedure for updating the regression coefficient parameter for each element 20. In the example of FIG. 2, a plurality of elements 20 are arranged along a first direction X and a second direction Y. A plurality of tasks are provided in the first direction X, and a plurality of feature values are provided in the second direction Y. Each element 20 is characterized by a task and a feature value.

FIG. 2 illustrates three elements 20 arranged in the first direction X, the rightmost element 20 is an update target element 20a, and two left elements 20 are non-update target elements 20b for which the regression coefficient parameter has already been updated. In the example of FIG. 2, when the regression coefficient parameter of the update target element 20a is updated, the regression coefficient parameter of another adjacent element 20b having the identical feature value is used. Thus, the regression coefficient parameter of the update target element 20a of FIG. 2 is updated by using the updated regression coefficient parameters of two left non-update target elements 20b.

As described above, the first embodiment is characterized in that the updated regression coefficient parameter is immediately used when the regression coefficient parameter of the update target element 20a is updated. Consequently, a previously updated regression coefficient parameter can be reflected in a newly updated regression coefficient parameter, and the accuracy of the regression coefficient parameter can be improved.

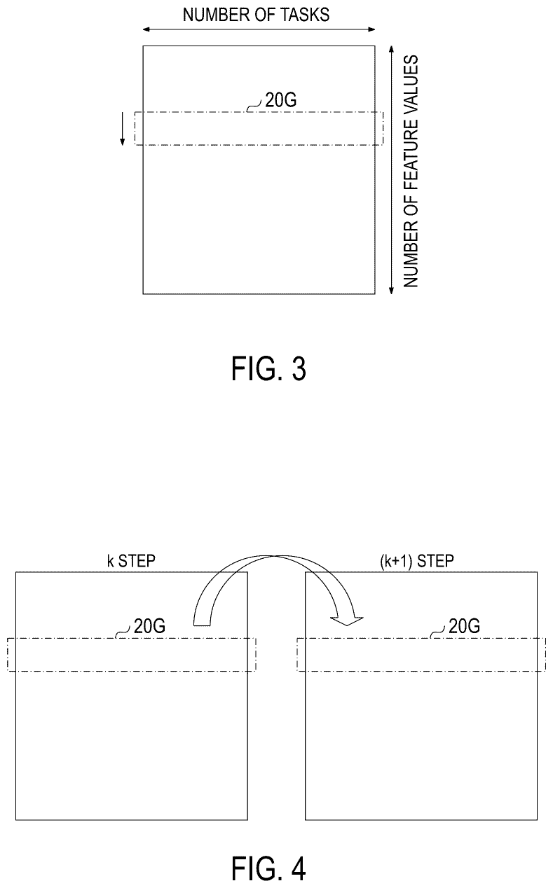

FIGS. 3 and 4 are diagrams illustrating a procedure for updating a regression coefficient parameter according to a comparative example. In one comparative example, as indicated by a dashed dotted line 20G, all the tasks are grouped for each feature value, and a plurality of regression coefficient parameters corresponding to the plurality of elements 20 are updated. In this case, as illustrated in FIG. 4, in order to update a regression coefficient parameter in a (k+1)-th number of times, the regression coefficient parameter of all tasks in a k-th number of times are used. Therefore, compared with the case where the updated regression coefficient parameter is immediately reflected, the accuracy of the regression coefficient parameter lowers.

In the information processing apparatus 1 according to the first embodiment, the regression coefficient parameter is updated by using a regularized log likelihood function. Specifically, the regression coefficient parameter can be updated by using the regularized log likelihood function in the Poisson distribution as the objective function. The regularized log likelihood function in the Poisson distribution is expressed by Equation (1).

$$\\ \begin{matrix}{max}_{B} \frac{1}{n} {\sum }_{i = 1}^{n} {\sum }_{j = 1}^{m} [ {y}_{ij} ( {β}_{0 j} + {\sum }_{k = 1}^{p} {x}_{ik} {β}_{kj} ) - exp ( {β}_{0 j} + {\sum }_{k = 1}^{p} {x}_{ik} {β}_{kj} ) - log {y}_{ij} ! ] - λ {\sum }_{k = 1}^{p} \sqrt{{\sum }_{j = 1}^{m} {β}_{kj}^{2}} & ( 1 )\end{matrix}$$

In Equation (1), n is the number of data, m is the number of tasks, and p is the number of feature values. i is an identification number of data, j is an identification number of the task, and k is an identification number of the feature value. βkj is a regression coefficient parameter, and λ is a regularization parameter. x is an explanatory variable, and y is an objective variable. B is a matrix that aligns a plurality of regression coefficient parameters, and max is a maximization problem regarding the term B.

Since it is difficult to solve Equation (1) as it is, the following Equation (2) is obtained by approximating a quadratic function of a regression coefficient parameter β by using Taylor expansion. B is a matrix that aligns a plurality of regression coefficient parameters, and min is a minimization problem regarding the term B.

$$\\ \begin{matrix}{min}_{B} \frac{1}{2 n} {\sum }_{i = 1}^{n} {\sum }_{j = 1}^{m} {{w}_{ij} ( {z}_{ij} - {β}_{0 j} - {\sum }_{k = 1}^{p} {x}_{ik} {β}_{kj} )}^{2} + λ {\sum }_{k = 1}^{p} \sqrt{{\sum }_{j = 1}^{m} {β}_{kj}^{2}} & ( 2 )\end{matrix}$$

In Equation (2), wij is expressed by Equation (3), and zij is expressed by Equation (4).

$$\\ \begin{matrix}{w}_{ij} = exp ( {\tilde{β}}_{0 j} + {\sum }_{k = 1}^{p} {x}_{ik} {\tilde{β}}_{kj} ) & ( 3 )\end{matrix}$$

$$\\ \begin{matrix}{z}_{ij} = {\tilde{β}}_{0 j} + {\sum }_{k = 1}^{p} {x}_{ik} {\tilde{β}}_{kj} + \frac{{y}_{ij} - {w}_{ij}}{{w}_{ij}} & ( 4 )\end{matrix}$$

In the present specification, a symbol obtained by adding ˜ (tilde) above the symbol β in the mathematical expression is expressed as “β tilde”. The β tilde represents a value of the regression coefficient parameter in the middle of update.

For example, in a case where defect analysis of a semiconductor wafer is performed by using Equation (2), n is the number of semiconductor wafers, m is the number of region divisions on the semiconductor wafer, and p is the number of defect factors of a semiconductor manufacturing apparatus, a semiconductor manufacturing process, and the like.

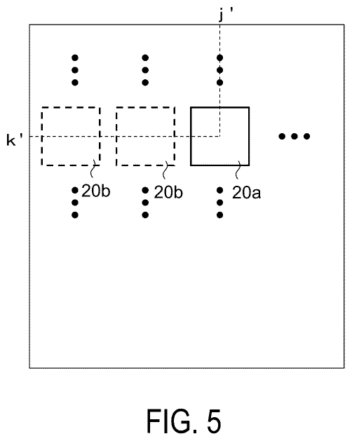

When a term β_{k′j′} including an update target parameter is extracted from Equation (2), the regularization term is divided into an update target regression coefficient parameter and a non-update target regression coefficient parameter, and the non-update target regression coefficient parameter is fixed to the value in the middle of update, the following Equation (5) is obtained. In the mathematical expression, a suffix of the update target parameter is added with a single quotation mark, and a suffix of the non-update target parameter is not added with a single quotation mark. The update target element 20a is provided, for example, at a position illustrated in FIG. 5.

$$\\ \begin{matrix}\frac{1}{2 n} {\sum }_{i = 1}^{n} {{w}_{{ij}^{′}} ( {z}_{{ij}^{′}} - {β}_{0 {j}^{′}} - {\sum }_{k = 1}^{p} {x}_{ik} {β}_{{kj}^{′}} )}^{2} + λ \sqrt{{β}_{{k}^{′} {j}^{′}}^{2} + {\sum }_{j \neq {j}^{′}} \tilde{β} {}_{{k}^{′} j}^{2}} & ( 5 )\end{matrix}$$

When all the values in the middle of update are 0 (β tilde k′j (j≠j′)=0), as represented in the following Equation (6), these values match an existing Lasso objective function.

$$\\ \begin{matrix}\frac{1}{2 n} {\sum }_{i = 1}^{n} {{w}_{{ij}^{′}} ( {z}_{{ij}^{′}} - {β}_{0 {j}^{′}} - {\sum }_{k = 1}^{p} {x}_{ik} {β}_{{kj}^{′}} )}^{2} + λ \vert {β}_{{k}^{′} {j}^{′}} \vert & ( 6 )\end{matrix}$$

A second term of Equation (5) is a regularization term. A first term β²_{k′j′} included in the regularization term is the square of the regression coefficient parameter of the update target selected by the update target selection unit 5. The second term included in the regularization term is the sum of squares of the regression coefficient parameters of all the elements not selected by the update target selection unit 5. Equation (6) is obtained by setting a second term of a regularization term to zero by the non-update target fixation unit 7. The second term of Equation (6) is a regularization term, and this regularization term is a value obtained by multiplying an absolute value of the update target regression coefficient parameter β_{k′j′} selected by the update target selection unit 5 by the regularization parameter λ. When an existing update rule is applied to Equation (6), β_{k′j′} is expressed by the following Equation (7).

$$\\ \begin{matrix}\hat{β} {}_{{k}^{′} {j}^{′}} = \frac{S ( {\sum }_{i = 1}^{n} \{ {w}_{ij ′} {x}_{ik ′}^{2} \tilde{β} {}_{{k}^{′} j ′} + ( {y}_{ij ′} - {w}_{ij ′} ) {x}_{ik ′} \} , n λ )}{{\sum }_{i = 1}^{n} {w}_{{ij}^{′}} {x}_{{ik}^{′}}^{2}} & ( 7 )\end{matrix}$$

In Equation (7), in order to indicate that the parameter is an updated parameter, “\hat{ }” (hat) is added above β_{k′j′}. S(x, λ) on a right side molecule of Equation (7) is expressed by the following Equation (8). Sign(x) of Equation (8) is a sign function, and for example, sign(x) is 1 when x>0, is 0 when x=0, and is −1 when x<0.

S(x,λ)=sign(x)max{|x|−λ,0} (8)

When a task j in which the β tilde k′j is not zero is present, a value differentiated with β_{k′j′} is set to zero, the following Equation (8) is obtained.

$$\\ \begin{matrix}{\sum }_{i = 1}^{n} {w}_{ij ′} ( {z}_{{ij}^{′}} - {β}_{0 {j}^{′}} - {\sum }_{k = 1}^{p} {x}_{ik} {β}_{kj ′} ) {x}_{ik ′} - n λ \frac{{β}_{{k}^{′} {j}^{′}}}{\sqrt{{β}_{{k}^{′} {j}^{′}}^{2} + {\sum }_{j \neq {j}^{′}} \tilde{β} {}_{{k}^{′} j}^{2}}} = 0 & ( 8 )\end{matrix}$$

Since β²_{k′j′} is included in a denominator of a second term on a left side of Equation (8), β_{k′j′} cannot be solved as it is. The denominator β_{k′j′} is fixed to the β tilde k′j′, and thus, an update expression of β_{k′j′} shown in the following Equation (9) is obtained.

$$\\ \begin{matrix}\hat{β} {}_{{k}^{′} {j}^{′}} = \frac{{\sum }_{i = 1}^{n} \{ {w}_{ij ′} {x}_{ik ′}^{2} \tilde{β} {}_{{k}^{′} j ′} + ( {y}_{ij ′} - {w}_{ij ′} ) {x}_{ik ′} \}}{{\sum }_{i = 1}^{n} {w}_{{ij}^{′}} {x}_{{ik}^{′}}^{2} + \frac{n λ}{\sqrt{{\sum }_{j = 1}^{m} \tilde{β} {}_{{k}^{′} j}^{2}}}} & ( 9 )\end{matrix}$$

When a value obtained by partially differentiating the first term of Equation (1) with β0j′ is set to zero and the expression is solved for β0j′, the following Equation (10) is obtained.

$$\\ \begin{matrix}{β}_{0 {j}^{′}} = {\tilde{β}}_{0 {j}^{′}} + \frac{{\sum }_{i = 1}^{n} {y}_{{ij}^{′}}}{{\sum }_{i = 1}^{n} {w}_{{ij}^{′}}} - 1 & ( 10 )\end{matrix}$$

Wij in Equation (10) is expressed by the following Equation (11) similarly to Equation (3) described above.

$$\\ \begin{matrix}{w}_{ij} = exp ( {\tilde{β}}_{0 j} + {\sum }_{k = 1}^{p} {x}_{ik} {\tilde{β}}_{kj} ) & ( 11 )\end{matrix}$$

In Equation (10), when all the regression coefficient parameters are initialized to zero, a second term on a right side of Equation (10) becomes a large value, and there is a concern that calculation by a computer overflows when wij is calculated. In an ordinary computer, overflow occurs at exp(710) or more in 64-bit floating-point calculation.

Therefore, in the first embodiment, as represented in the following Equation (12), a value of β0j′ is determined such that calculation results of a second term and a third term on the right side of Equation (10) are zero.

$$\\ \begin{matrix}\frac{{\sum }_{i = 1}^{n} {y}_{{ij}^{′}}}{{\sum }_{i = 1}^{n} {w}_{{ij}^{′}}} - 1 = 0 & ( 12 )\end{matrix}$$

When the regularization parameter A is sufficiently large, since the β tilde kj can be regarded as zero, Equation (11) is deformed as Equation (13).

wij′=exp(β0j′) (13)

When Equation (13) is substituted into Equation (12), the following Equation (14) is obtained.

$$\\ \begin{matrix}\frac{{\sum }_{i = 1}^{n} {y}_{{ij}^{′}}}{n exp ( {\tilde{β}}_{0 {j}^{′}} )} - 1 = 0 & ( 14 )\end{matrix}$$

When Equation (14) is solved for β0j′, the following Equation (15) is obtained.

$$\\ \begin{matrix}{\tilde{β}}_{0 {j}^{′}} = log ( \frac{1}{n} {\sum }_{i = 1}^{n} {y}_{{ij}^{′}} ) & ( 15 )\end{matrix}$$

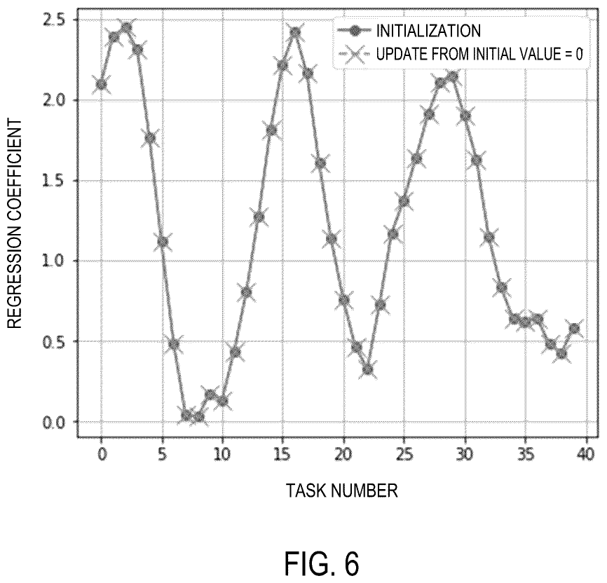

As can be seen from a right side of Equation (15), the regression coefficient parameter obtained by Equation (15) has a value corresponding to a calculation result of the sum of the objective variables. FIG. 6 is a diagram illustrating an update result of the regression coefficient parameter in a case where initialization is performed in Equation (15) and in a case where an initial value is set to zero. In FIG. 6, the regression coefficient parameter in a case where initialization is performed in Equation (15) is indicated by a black circle, and the regression coefficient parameter updated from the initial value=zero is indicated by ×. As can be seen from FIG. 6, the regression coefficient parameters are matched in both cases, and it can be seen that it is appropriate to initialize the intercept by Equation (15).

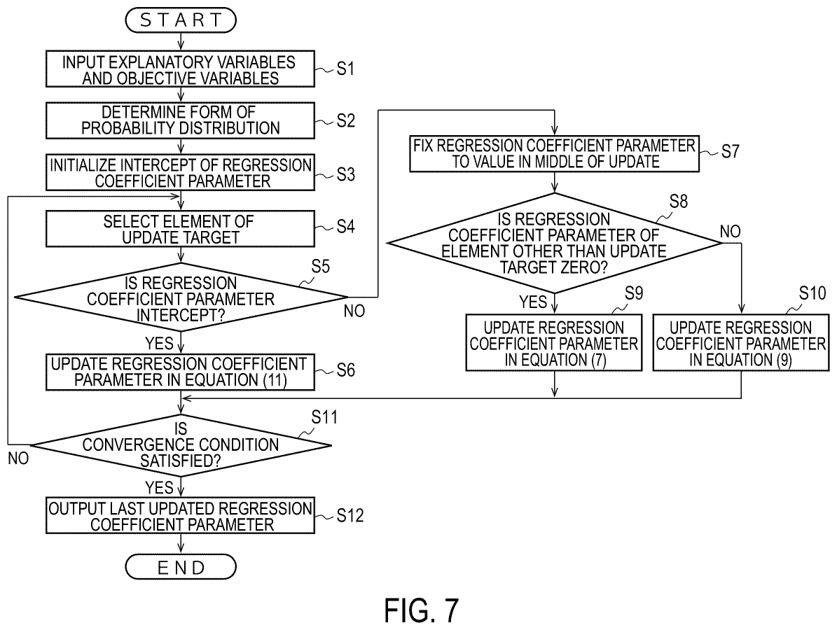

FIG. 7 is a flowchart illustrating the processing operation of the information processing apparatus 1 according to the first embodiment. First, the explanatory variable X and the objective variable Y are input from the input unit 2 (step S1). Subsequently, the distribution determination unit 3 determines the form of the probability distribution followed by the objective variable (step S2). Examples of the form of the probability distribution include a Gaussian distribution and a Poisson distribution.

Subsequently, the intercept initialization unit 4 initializes the intercept of the regression coefficient parameter in accordance with the form of the probability distribution (step S3). Since a procedure for initializing the intercept varies depending on the form of the probability distribution, the processing procedure of step S3 varies depending on the determination result of step S2. In addition, the initialization processing in step S3 may be omitted depending on the form of the probability distribution. In a case where the probability distribution is the Poisson distribution, the intercept of the regression coefficient parameter is initialized by the processing procedures of Equations (10) to (15) described above.

Subsequently, the update target selection unit 5 selects the update target element 20 (step S4). As described with reference to FIG. 2, in the first embodiment, since the regression coefficient parameter is updated for each element 20 characterized by the task and the feature value, one element 20 is selected in principle in step S4. As will be described later, in a case where the kinds of processing of updating the plurality of elements 20 are performed in parallel, the plurality of elements 20 may be simultaneously selected.

Subsequently, the intercept determination unit 6 determines whether or not the regression coefficient parameter of the element 20 selected in step S4 is the intercept (step S5). In the determination processing of step S5, for example, when a feature value k of the element 20 is 0, it is determined that the parameter is the intercept. That is, when the circuit coefficient parameter of the element 20 is β0j, it is determined that the parameter is the intercept.

In a case where it is determined in step S5 that the update target element 20 is the intercept, the calculation expression selection unit 8 selects the calculation expression of Equation (11), and the parameter update unit 9 updates the regression coefficient parameter based on this calculation expression (step S6).

In a case where it is determined in step S5 that the update target element 20 is not the intercept, the non-update target fixation unit 7 fixes the non-update target regression coefficient parameter in the regularization term to a value in the middle of update (step S7). In step S7, for example, the calculation of Equation (5) is performed.

Subsequently, it is determined whether or not all the regression coefficient parameters of the elements 20 other than the update target element 20 are zero (step S8).

In a case where step S8 is YES, the calculation expression selection unit 8 selects the calculation expression of Equation (7), and the parameter update unit 9 updates the regression coefficient parameter based on this calculation expression (step S9). In a case where step S8 is NO, the calculation expression selection unit 8 selects the calculation expression of Equation (9), and the parameter update unit 9 updates the regression coefficient parameter based on this calculation expression (step S10).

When the processing of step S6, S9, or S10 is ended, the end determination unit 10 determines whether or not the regression coefficient parameter satisfies a predetermined convergence condition (step S11). In a case where the convergence condition is not satisfied, kinds of processing of step S4 and subsequent steps are repeated. In a case where the convergence condition is satisfied, the last updated regression coefficient parameter is output from the output unit 11 (step S12).

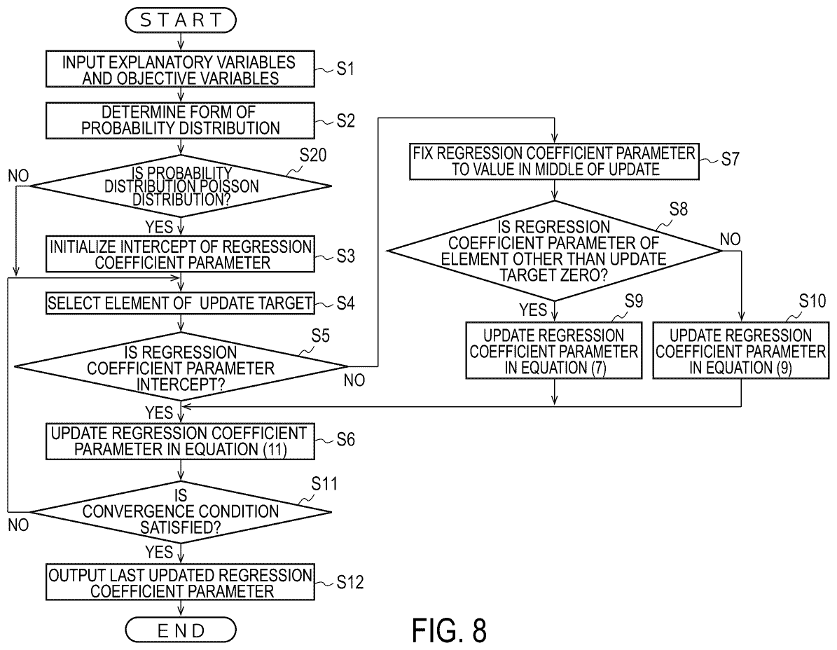

FIG. 8 is a flowchart according to an example in which FIG. 7 is further embodied. In FIG. 8, the same step number will be assigned to the processing common to the processing in FIG. 7, and differences will be mainly described below. The flowchart of FIG. 8 illustrates an example in which the form of the probability distribution determined by the distribution determination unit 3 is a Gaussian distribution or a Poisson distribution. Thus, after step S2, processing of determining whether or not the distribution is the Gaussian distribution or the Poisson distribution is provided (step S20). When step S20 is YES and it is determined that the distribution is the Poisson distribution, kinds of processing of steps S3 to S12 are performed. On the other hand, when step S20 is NO and it is determined that the distribution is the Gaussian distribution, the processing of step S3 is omitted, and the kinds of processing of steps S4 to S12 are performed. As described above, in a case where it is determined in step S20 of FIG. 8 that the distribution is the Poisson distribution, the intercept of the regression coefficient parameter is initialized by Equation (15). On the other hand, in a case where it is determined that the distribution is not the Poisson distribution, since it is not always necessary to initialize the intercept, the processing after step S4 is performed without initializing the intercept of the regression coefficient parameter. Thus, the determination processing of step S20 corresponds to the determination processing of the intercept initialization determination unit. The calculation expression selection unit 8 selects a different calculation expression depending on whether or not the distribution is the Poisson distribution and updates the regression coefficient parameter.

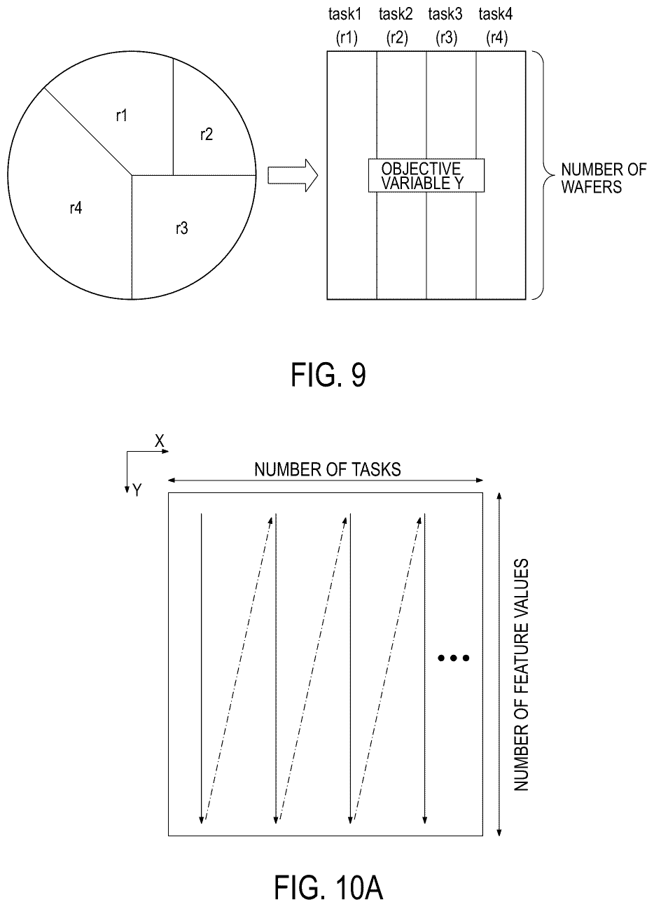

The flowcharts illustrated in FIGS. 7 and 8 can be used, for example, for the defect analysis of the semiconductor wafer. FIG. 9 is a diagram for describing a task and an objective variable Y when defect analysis of a semiconductor wafer is performed. In the defect analysis of the semiconductor wafer, for example, an in-plane defect rate of the semiconductor wafer is set as the objective variable Y. An element forming surface of the semiconductor wafer is divided into a plurality of regions, and each region is set as a task. A certain feature value of each region is set as an explanatory variable X. The feature value is, for example, a process of manufacturing a semiconductor wafer, a type of a semiconductor manufacturing apparatus, a manufacturing date of the semiconductor wafer, a type of a chamber used for manufacturing the semiconductor wafer, and the like. FIG. 9 illustrates an example in which the element forming surface of the semiconductor wafer is divided into four regions r1 to r4.

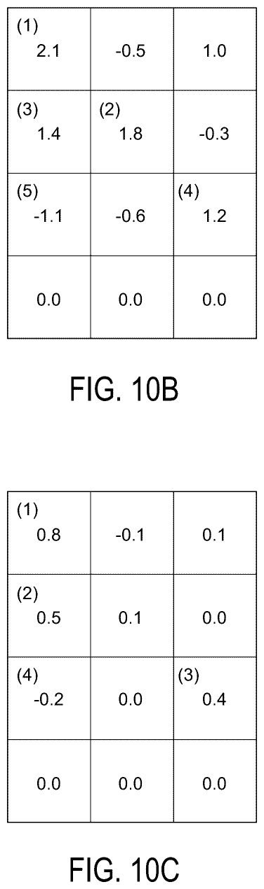

Next, the processing procedure of the update target selection unit 5 of step S4 of FIGS. 7 and 8 will be described in detail. FIGS. 10A, 10B, and 10C are diagrams for describing the processing procedure of the update target selection unit 5. FIG. 10A adopts a method for selecting each element 20 in an arrangement order of the elements 20 (hereinafter, a first selection method). In FIG. 10B, a method (hereinafter, a second selection method) for selecting each element 20 in descending order of an absolute value of the regression coefficient parameter is adopted. FIG. 10C adopts a method for selecting each element 20 in descending order of an absolute value of a difference before and after the update of the regression coefficient parameters (hereinafter, a third selection method). The update target selection unit 5 can select, for example, any one of the first to third selection methods.

In the first selection method illustrated in FIG. 10A, the update target selection unit 5 selects the elements 20 one by one along the second direction Y in which the feature values as the explanatory variables are arranged, and updates the regression coefficient parameter in a state where a leftmost task is selected among the plurality of tasks arranged in the first direction X. When the update of the element 20 corresponding to the last feature value is completed, the task is shifted to the right by one and a similar selection operation is repeated. As described above, in the first selection method illustrated in FIG. 10A, the elements 20 are selected one by one in the arrangement order of the task and the feature value to update the regression coefficient parameter.

In the second selection method illustrated in FIG. 10B, the update target selection unit 5 selects the plurality of elements 20 in descending order of the absolute value of the regression coefficient parameter. In the example of FIG. 10B, the regression coefficient parameter is selected in the order of the element 20 of 2.1, the element 20 of 1.8, the element 20 of 1.4, the element 20 of 1.2, and the element 20 of −1.1. The reason why the element is selected in descending order of the absolute value of the regression coefficient parameter is that it is considered that the influence on the objective variable is larger as the explanatory variable has a larger regression coefficient parameter.

In the third selection method illustrated in FIG. 10C, the update target selection unit 5 selects the plurality of elements 20 in descending order of the absolute value of the difference before and after the update of the regression coefficient parameters. When the values of FIG. 10C express differences before and after the update of the regression coefficient parameters, the element 20 in an upper left end is selected first, and then the element 20 of which a difference is 0.8 is selected, and then the element 20 of which a difference is 0.4 is selected, and then the element 20 of which a difference is −0.2 is selected. The reason why the element is selected in descending order of the absolute value of the difference before and after the update of the regression coefficient parameters is that it is considered that the influence on the objective variable is larger as the explanatory variable has a larger absolute value of the difference.

The method for selecting the element 20 by the update target selection unit 5 is arbitrary and is not limited to the methods illustrated in FIGS. 10A to 10C.

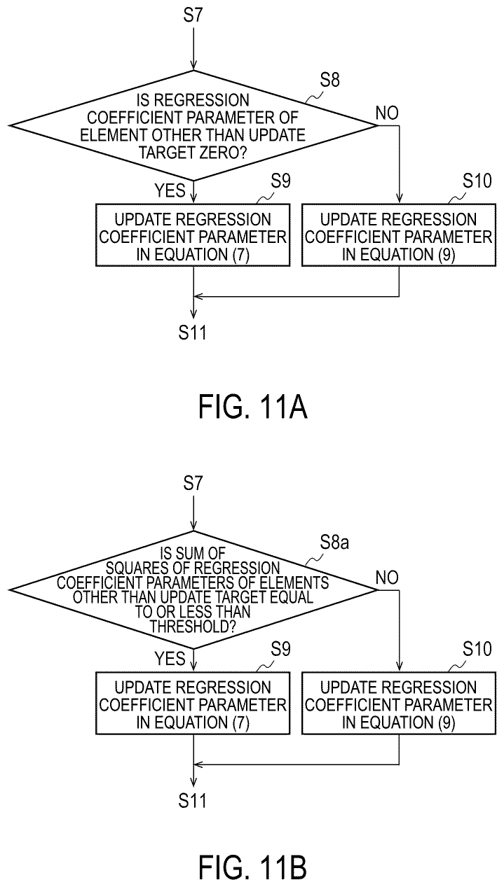

FIGS. 11A and 11B are diagrams for describing the processing procedure of the calculation expression selection unit 8 of steps S8 to S10 in FIGS. 7 and 8. FIG. 11A is a flowchart for describing the first selection method performed by the calculation expression selection unit 8, and FIG. 11B is a flowchart for describing the second selection method performed by the calculation expression selection unit 8.

In the first selection method of FIG. 11A, as shown in step S8 of FIGS. 7 and 8, it is determined whether or not all the regression coefficient parameters other than the update target regression coefficient parameter are zero (step S8). When it is determined that step S8 is YES (zero), the processing of step S9 is performed, and when it is determined that step S8 is NO (there is the regression coefficient parameter that is not zero), the processing of step S10 is performed.

In the second selection method of FIG. 11B, it is determined whether or not the sum of squares of all regression coefficient parameters other than the update target regression coefficient parameter is equal to or less than a predetermined threshold (step S8a). In a case where step S8a is YES (equal to or less than the threshold), the processing of step S9 is performed. In a case where step S8a is NO (larger than the threshold), the processing of step S10 is performed. In the case of FIG. 11B, when the threshold is zero, the processing is identical to the processing of FIG. 11A.

As described above, in the first embodiment, instead of collectively updating the regression coefficient parameters of the plurality of elements 20 having the identical feature value (explanatory variable), the regression coefficient parameter is updated for each element 20 by using the previously updated regression coefficient parameter of another element 20. Consequently, the updated regression coefficient parameter of a certain element 20 can be immediately used for updating the regression coefficient parameter of the next element 20, and the accuracy of the regression coefficient parameter can be improved. In addition, the form of the probability distribution of the objective variable is determined, and the intercept of the regression coefficient parameter is initialized in accordance with the probability distribution of the objective variable. Consequently, the regression coefficient parameter can be updated by fixing the intercept, there is no concern that the calculation of the regression coefficient parameter becomes inexecutable, and the regression coefficient parameter can be updated quickly and accurately.

In addition, in a case where the regression coefficient parameter is not the intercept, the non-update target regression coefficient parameter in the regularization term is fixed to the value in the middle of update, and the calculation expression for updating the regression coefficient parameter is switched depending on whether or not all the non-update target regression coefficient parameters are zero. Consequently, the regression coefficient parameter can be calculated quickly and accurately.

### Second Embodiment

An information processing apparatus 1 according to a second embodiment has a block configuration similar to the block diagram of FIG. 1. The information processing apparatus 1 according to the second embodiment performs processing based on a flowchart similar to the flowchart of FIG. 7 or FIG. 8, but the processing operation performed by the update target selection unit 5 in step S4 of FIGS. 7 and 8 is different from the processing operation in the first embodiment. The update target selection unit 5 according to the second embodiment can simultaneously select the plurality of elements 20.

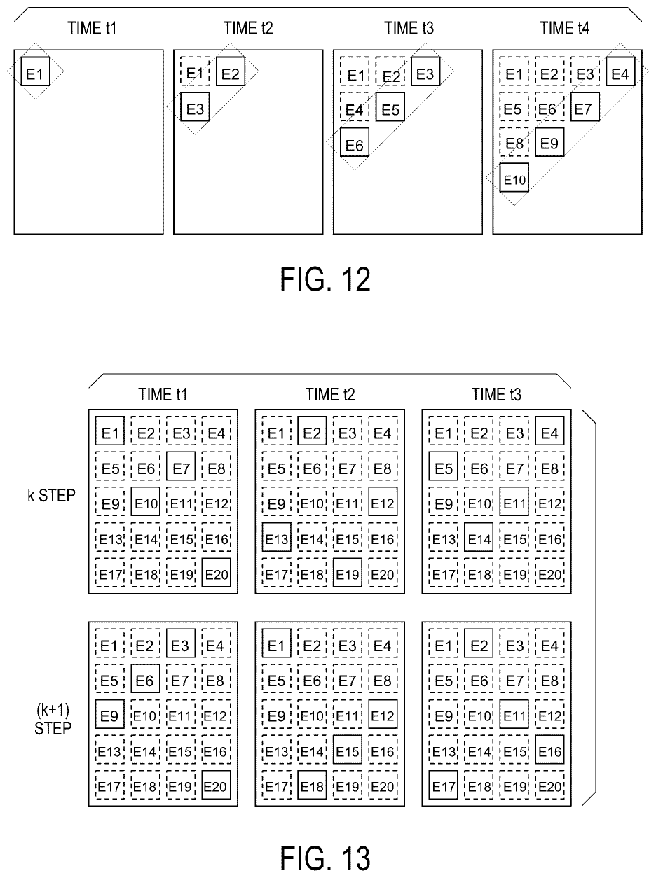

FIG. 12 is a diagram for describing the element 20 selected by the update target selection unit 5. In FIG. 12, the elements 20 are denoted as elements E1 to E10. At time t1, only the element E1 is selected. In this case, the information processing apparatus 1 according to the second embodiment updates a regression coefficient parameter of the element E1 by using a regression coefficient parameter of another element 20 updated in the previous number of times (step) or an initial value of the regression coefficient parameter prepared in advance.

At time t2, the update target selection unit 5 selects the elements E2 and E3. The element E2 is arranged to the right of the element E1. Thus, for the element E2, the regression coefficient parameter is updated by using the updated regression coefficient parameter of the element E1. On the other hand, for the element E3, the regression coefficient parameter of the element E3 is updated by using the regression coefficient parameter of another element 20 updated in the previous number of times (step) or the initial value of the regression coefficient parameter prepared in advance. The kinds of processing of updating the regression coefficient parameters of the elements E2 and E3 are performed in parallel.

At time t3, the update target selection unit 5 selects the elements E3, E5, and E6. For the element E3, the regression coefficient parameter is updated by using the updated regression coefficient parameters of the elements E1 and E2. In addition, for the element E5, the regression coefficient parameter is updated by using the regression coefficient parameter of the element E4 updated in the previous number of times. In addition, for the element E6, the regression coefficient parameter of the element E6 is updated by using the regression coefficient parameter of another element 20 updated in the previous number of times (step) or the initial value of the regression coefficient parameter prepared in advance. The kinds of processing of updating the regression coefficient parameters of the elements E3, E5, and E6 are performed in parallel.

At time t4, the update target selection unit 5 selects the elements E4, E7, E9, and E10. For the element E4, the regression coefficient parameter is updated by using the updated regression coefficient parameters of the elements E1 to E3. In addition, for the element E7, the regression coefficient parameter is updated by using the updated regression coefficient parameters of the elements E5 and E6. In addition, for E9, the regression coefficient parameter is updated by using the updated regression coefficient parameter of the element E8. For the element E10, the regression coefficient parameter is updated by using the regression coefficient parameter of another element 20 updated in the previous number of times (step) or the initial value of the regression coefficient parameter prepared in advance. The kinds of processing of updating the regression coefficient parameters of the elements E4, E7, E9, and E10 are performed in parallel.

FIG. 12 illustrates an example in which the plurality of elements 20 are simultaneously selected in the arrangement order of the plurality of elements 20 depending on the time and the kinds of processing of updating the regression coefficient parameter of the elements 20 are performed in parallel. However, the update target selection unit 5 does not necessarily need to select the plurality of elements 20 in the arrangement order.

FIG. 13 is a diagram illustrating an example in which the update target selection unit 5 schedules in advance the element 20 to be selected for each time. In FIG. 13, the elements 20 are denoted as elements E1 to E20. In the example of FIG. 13, the update target selection unit 5 selects the elements E1, E7, E10, and E20 at time t1 of a k step, selects the elements E2, E12, E13, and E19 at time t2, and selects the elements E4, E5, E11, and E14 at time t3. In addition, the update target selection unit 5 selects the elements E3, E6, E9, and E20 at time t1 of a k+1 step, selects the elements E1, E12, E15, and E18 at time t2, and selects the elements E2, E11, E16, and E17 at time t3.

FIGS. 12 and 13 are specific examples of the element 20 selected by the update target selection unit 5, and two or more elements 20 selected simultaneously can be changed as appropriate.

As described above, in the information processing apparatus 1 according to the second embodiment, since the update target selection unit 5 can simultaneously select the plurality of elements 20, the kinds of processing of updating the regression coefficient parameters of the plurality of elements 20 can be performed in parallel, and the update processing can be performed more quickly.

At least a part of the information processing apparatus 1 described in the above-described embodiments may be achieved by hardware or software. In a case where the at least a part thereof is achieved by software, a program that achieves at least a part of the functions of the information processing apparatus 1 may be stored in a recording medium such as a flexible disk or a CD-ROM, and may be read and executed by a computer. The recording medium is not limited to an attachable and detachable medium such as a magnetic disk or an optical disk, and may be a fixed recording medium such as a hard disk device or a memory.

The program of executing at least a portion of the functions performed by the transmitter 1 and the receiver 2 may be distributed via a communication line such as Internet. The program may be distributed via a wired line or a wireless line such as Internet at a state of encrypting, modulating or compressing the program, or may be distributed at a state of being stored in the recording media.

The above-described examples may be configured as follows.

(1) An information processing apparatus that updates a regression coefficient parameter based on a predetermined objective function including a regularization term for each of a plurality of elements characterized by a task and a feature value, the information processing apparatus comprising processing circuitry, the processing circuitry configured to:
select an element which is an update target of the regression coefficient parameter from the plurality of elements;
fix a value of the regularization term of an unselected element;
select a calculation expression for updating a regression coefficient parameter of the selected element based on a regression coefficient parameter of the unselected element; and
update the selected regression coefficient parameter of the selected element based on the selected calculation expression.

(2) The information processing apparatus according to (1),
wherein the regularization term includes a first term for the selected element and a second term for all unselected elements, and
the processing circuitry is further configured to set the second term to zero, and sets a value obtained by multiplying an absolute value of the regression coefficient parameter of the selected element by a regularization parameter to the regularization term.

(3) The information processing apparatus according to (1) or (2),
wherein the processing circuitry is further configured to determine whether or not the regression coefficient parameter of the selected element corresponds to an intercept of the regression coefficient parameter, and
wherein the processing circuitry is configured to switch the calculation expression of the selected element depending on whether or not it is determined that the regression coefficient parameter corresponds to the intercept.

(4) The information processing apparatus according to (3),
wherein, in a case where it is determined that the regression coefficient parameter corresponds to the intercept, the processing circuitry is configured to select a calculation expression for calculating a regression coefficient parameter corresponding to the intercept.

(5) The information processing apparatus according to (4),
wherein, in a case where it is determined that the regression coefficient parameter corresponds to the intercept, the processing circuitry is configured to select one of calculation expressions different from each other depending on whether or not the intercept is initialized.

(6) The information processing apparatus according to (5),
wherein the processing circuitry is further configured to determine a form of a probability distribution of an objective variable calculated by inputting an explanatory variable and the regression coefficient parameter to the objective function;
determine whether or not the intercept is initialized based on the form of the determined probability distribution; and
initialize the intercept when it is determined that the intercept is initialized,
wherein, in a case where it is determined that the regression coefficient parameter corresponds to the intercept and in a case where the intercept is initialized, the processing circuitry is configured to select the calculation expression for calculating a sum of objective variables.

(7) The information processing apparatus according to (6),
wherein, in a case where it is determined that the probability distribution is a Poisson distribution, the processing circuitry is configured to select the element which is the update target of the regression coefficient parameter after the intercept is initialized.

(8) The information processing apparatus according to (6),
wherein, in a case where it is determined that the probability distribution is a Gaussian distribution, the processing circuitry is configured to select the element of the update target of the regression coefficient parameter without initializing the intercept.

(9) The information processing apparatus according to any one of (1) to (8),
wherein the processing circuitry is configured to select the element in an arrangement order of the plurality of elements.

(10) The information processing apparatus according to any one of (1) to (8),
wherein the processing circuitry is configured to select the element in descending order of an absolute value of the regression coefficient parameter among the plurality of elements.

(11) The information processing apparatus according to any one of (1) to (8),
wherein the processing circuitry is configured to select the element in descending order of an absolute value of a difference value of the regression coefficient parameter before and after the update of the regression coefficient parameter among the plurality of elements.

(12) The information processing apparatus according to any one of (1) to (11),
wherein the processing circuitry is configured to switch the calculation expression depending on whether or not regression coefficient parameters of all unselected elements are zero.

(13) The information processing apparatus according to any one of (1) to (11),
wherein the processing circuitry is configured to switch the calculation expression depending on whether or not a sum of squares of regression coefficient parameters of all unselected elements is less than or equal to a predetermined threshold.

(14) The information processing apparatus according to any one of (1) to (13),
wherein the processing circuitry is further configured to determine whether or not the updated regression coefficient parameter satisfies a predetermined convergence condition,
wherein the processing circuitry is configured to update the regression coefficient parameters of the plurality of elements repeatedly until the predetermined convergence condition is satisfied.

(15) The information processing apparatus according to any one of (1) to (14),
wherein the plurality of elements are arranged in a first direction in which different tasks are assigned and a second direction in which different feature values are assigned,
the processing circuitry is configured to simultaneously select, as update targets, two or more elements having different tasks and different feature values, and
the processing circuitry is configured to update regression coefficient parameters of the two or more elements selected in parallel.

(16) The information processing apparatus according to (15),
wherein, when regression coefficient parameters of the plurality of elements in n-th number of times (n is an integer of 2 or more) for the plurality of elements is updated, the processing circuitry is configured to select a calculation expression for updating a regression coefficient parameter of the selected element based on a regression coefficient parameter of an unselected element and already updated in the n-th number of times.

(17) The information processing apparatus according to any one of (1) to (16),
wherein an element forming surface of a semiconductor substrate is divided into a plurality of regions,
each of the plurality of regions has specific task and feature value, and
an objective variable is set based on the feature value for the task for each semiconductor substrate.

(18) The information processing apparatus according to (17),
wherein the objective variable includes a defect rate of the semiconductor substrate.

(19) The information processing apparatus according to (17),
wherein the feature value includes at least one of a manufacturing process of the semiconductor substrate, a type of a semiconductor manufacturing apparatus, a manufacturing date of the semiconductor substrate, or a type of a chamber used for manufacturing the semiconductor substrate.

(20) An information processing method for updating a regression coefficient parameter based on a predetermined objective function including a regularization term for each of a plurality of elements characterized by a task and a feature value, the method comprising:
selecting an element which is an update target of the regression coefficient parameter from the plurality of elements;
fixing a value of the regularization term of an unselected element;
selecting a calculation expression for updating a regression coefficient parameter of the selected element based on a regression coefficient parameter of the unselected element; and
updating the regression coefficient parameter of the selected element based on the selected calculation expression.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. An information processing apparatus that updates a regression coefficient parameter based on a predetermined objective function including a regularization term for each of a plurality of elements characterized by a task and a feature value, the information processing apparatus comprising processing circuitry, the processing circuitry configured to:
select an element which is an update target of the regression coefficient parameter from the plurality of elements;
fix a value of the regularization term of an unselected element;
select a calculation expression for updating a regression coefficient parameter of the selected element based on a regression coefficient parameter of the unselected element; and
update the regression coefficient parameter of the selected element based on the selected calculation expression.

2. The information processing apparatus according to claim 1,
wherein the regularization term includes a first term for the selected element and a second term for all unselected elements, and
the processing circuitry is further configured to set the second term to zero, and to set a value obtained by multiplying an absolute value of the regression coefficient parameter of the selected element by a regularization parameter to the regularization term.

3. The information processing apparatus according to claim 1,
wherein the processing circuitry is further configured to determine whether or not the regression coefficient parameter of the selected element corresponds to an intercept of the regression coefficient parameter, and
wherein the processing circuitry is configured to switch the calculation expression of the selected element depending on whether or not it is determined that the regression coefficient parameter corresponds to the intercept.

4. The information processing apparatus according to claim 3,
wherein, in a case where it is determined that the regression coefficient parameter corresponds to the intercept, the processing circuitry is configured to select a calculation expression for calculating a regression coefficient parameter corresponding to the intercept.

5. The information processing apparatus according to claim 4,
wherein, in a case where it is determined that the regression coefficient parameter corresponds to the intercept, the processing circuitry is configured to select one of calculation expressions different from each other depending on whether or not the intercept is initialized.

6. The information processing apparatus according to claim 5,
wherein the processing circuitry is further configured to determine a form of a probability distribution of an objective variable calculated by inputting an explanatory variable and the regression coefficient parameter to the objective function;
determine whether or not the intercept is initialized based on the form of the determined probability distribution; and
initialize the intercept when it is determined that the intercept is initialized,
wherein, in a case where it is determined that the regression coefficient parameter corresponds to the intercept and in a case where the intercept is initialized, the processing circuitry is configured to select the calculation expression for calculating a sum of objective variables.

7. The information processing apparatus according to claim 6,
wherein, in a case where it is determined that the probability distribution is a Poisson distribution, the processing circuitry is configured to select the element which is the update target of the regression coefficient parameter after the intercept is initialized.

8. The information processing apparatus according to claim 6,
wherein, in a case where it is determined that the probability distribution is a Gaussian distribution, the processing circuitry is configured to select the element of the update target of the regression coefficient parameter without initializing the intercept.

9. The information processing apparatus according to claim 1,
wherein the processing circuitry is configured to select the element in an arrangement order of the plurality of elements.

10. The information processing apparatus according to claim 1,
wherein the processing circuitry is configured to select the element in descending order of an absolute value of the regression coefficient parameter among the plurality of elements.

11. The information processing apparatus according to claim 1,
wherein the processing circuitry is configured to select the element in descending order of an absolute value of a difference value of the regression coefficient parameters before and after the update of the regression coefficient parameter among the plurality of elements.

12. The information processing apparatus according to claim 1,
wherein the processing circuitry is configured to switch the calculation expression depending on whether or not regression coefficient parameters of all unselected elements are zero.

13. The information processing apparatus according to claim 1,
wherein the processing circuitry is configured to switch the calculation expression depending on whether or not a sum of squares of regression coefficient parameters of all unselected elements is less than or equal to a predetermined threshold.

14. The information processing apparatus according to claim 1,
wherein the processing circuitry is further configured to determine whether or not the updated regression coefficient parameter satisfies a predetermined convergence condition,
wherein the processing circuitry is configured to update the regression coefficient parameters of the plurality of elements repeatedly until the predetermined convergence condition is satisfied.

15. The information processing apparatus according to claim 1,
wherein the plurality of elements are arranged in a first direction in which different tasks are assigned and a second direction in which different feature values are assigned,
the processing circuitry is configured to simultaneously select, as update targets, two or more elements having different tasks and different feature values, and
the processing circuitry is configured to update regression coefficient parameters of the two or more elements selected in parallel.

16. The information processing apparatus according to claim 15,
wherein, when regression coefficient parameters of the plurality of elements in n-th number of times (n is an integer of 2 or more) for the plurality of elements is updated, the processing circuitry is configured to select a calculation expression for updating a regression coefficient parameter of the selected element based on a regression coefficient parameter of an unselected element and already updated in the n-th number of times.

17. The information processing apparatus according to claim 1,
wherein an element forming surface of a semiconductor substrate is divided into a plurality of regions,
each of the plurality of regions has specific task and feature value, and
an objective variable is set based on the feature value for the task for each semiconductor substrate.

18. The information processing apparatus according to claim 17,
wherein the objective variable includes a defect rate of the semiconductor substrate.

19. The information processing apparatus according to claim 17,
wherein the feature value includes at least one of a manufacturing process of the semiconductor substrate, a type of a semiconductor manufacturing apparatus, a manufacturing date of the semiconductor substrate, or a type of a chamber used for manufacturing the semiconductor substrate.

20. An information processing method for updating a regression coefficient parameter based on a predetermined objective function including a regularization term for each of a plurality of elements characterized by a task and a feature value, the method comprising:
selecting an element which is an update target of the regression coefficient parameter from the plurality of elements;
fixing a value of the regularization term of an unselected element;
selecting a calculation expression for updating a regression coefficient parameter of the selected element based on a regression coefficient parameter of the unselected element; and
updating the regression coefficient parameter of the selected element based on the selected calculation expression.
